(19) United States
(12) Patent Application Publication
(10) Pub. No.: US 2022/0053777 A1
(43) Pub. Date: Feb. 24, 2022

(54) NON-TOXIC ANT-REPELLING GEL

(71) Applicant: Dennis B. Jenkins, Brentwood, CA (US)

(72) Inventor: Dennis B. Jenkins, Brentwood, CA (US)

(21) Appl. No.: 17/454,052

(22) Filed: Nov. 8, 2021

Related U.S. Application Data
(63) Continuation-in-part of application No. 14/311,336, filed on Jun. 22, 2014, now abandoned.
(60) Provisional application No. 61/838,343, filed on Jun. 24, 2013.

(51) Int. Cl. A01N 65/24; A01N 25/04; A01N 25/24; A01P 17/00; A01N 25/10

(52) U.S. Cl. CPC A01N 65/24; A01N 25/04; A01N 25/10; A01P 17/00; A01N 25/24

(57) ABSTRACT

A natural non-toxic ant-repelling gel or tape is created by combining certain fatty acids with a thickening agent. The gel or tape has the surprising ability to be used safely around food, children and pets, because it is derived from an edible source. Over time, the gel composition hardens to become less tacky, thicker and more resilient and resistant to wear and tear. The gel or tape is applied to permanently block or repel ants. Since this is an oil-based gel composition, it is also long-lasting and water-proof, so it can be used outside. One particular use is to block the path of ants attempting to access a hummingbird feeder or nectar bird feeder.

### RELATED APPLICATIONS

This Application is a Continuation-In-Part application of U.S. patent application Ser. No. 14/311,336 filed Jun. 22, 2014, entitled “NON-TOXIC, ANT-REPELLING GEL”, Attorney Docket No. SLI-201, which is incorporated herein by reference in its entirety, and claims any and all benefits to which it is entitled therefrom. This application also claims the benefit of Provisional Application 61/838,343, filed on Jun. 24, 2013, entitled “Non-Toxic Insect-Repelling Gel”, and is incorporated by reference herein in its entirety.

### FIELD OF THE INVENTION

The present invention relates to a method, composition and kit for repelling ants, using natural non-toxic components. The present invention also relates to methods, compositions and kits, for blocking and repelling ants from accessing nectar bird feeders.

### BACKGROUND OF THE INVENTION

For millenia, ants have been invading human foodstuffs and dwellings. Numerous strategies have been devised to kill or repel ants (U.S. Pat. Nos. 4,874,611, 5,589,181, 4,349,553, EP2230914B1). Most of the existing strategies are hazardous and pose a threat to humans, birds and animals. There is a benefit to the environment in reducing the use of insecticides, and developing non-toxic solutions for controlling insects. People also desire effective solutions that do not involve toxic chemicals or insect killing strategies, such as a non-toxic reagent which could repel, or keep ants from invading a particular area or object.

There is a special need to protect hummingbird nectar feeders and oriole nectar feeders from ants. Since ants are very attracted to sugar, they are strongly drawn to the sugar solutions within a hummingbird nectar feeder. Once the ants have discovered this food source, they are highly motivated, and will persist in overcoming obstacles to reach it. Any solution needs to be safe and non-toxic since it is in close contact to the birds and their food.

We have discovered a surprisingly effective method of repelling ants, using a compound that is so safe it can be used around food, pets, birds and children. The invention also provides a long-lasting solution, since it relies on stable natural compounds, that remain effective for months.

There are physical devices which claim to be ant barriers (U.S. Pat. Nos. 7,793,461, 6,012,414), but they require purchasing and installing additional equipment. The current invention can be used directly on any existing feeder or feeder support, without additional equipment.

### SUMMARY OF INVENTION AND ADVANTAGES

By combining certain fatty acids, such as oleic acid, with a thickening agent we have discovered a natural non-toxic gel that has the surprisingly ability to strongly repel ants. This gel can be placed across access points to permanently repel and block ants. The reason that this formulation works so effectively is that ants sense by using chemical signals, and oleic acid is detected by ants as the smell of dead ants. To them it is as offensive as cadaverine and the smell of corpses is to humans. It therefore triggers their necrophobic instinct to flee. When ants detect the gel they literally run in the opposite direction, frantically clean themselves off, and abandon any attempt to enter the area again.

Since this is an oil-based gel composition, it is also long-lasting and water-proof, so it will endure outside exposure over long periods. One inventive use is to block the path of ants attempting to access a hummingbird feeder or nectar bird feeder. By drawing a thin line of gel around a supporting pole or hook, the invention is effective in permanently stopping ants from getting to the known sugar source of the nectar in hummingbird feeders. The ants will give up trying to penetrate the line of the repellent gel, and abandon the area. And it is safe enough to use around birds.

One example of the formula is an oleic acid combined with fumed silica to form a gel. The fumed silica is also a physical irritant to the ants and helps create a permanent physical and chemical barrier. Physical property testing reveals this gel has shear-thinning flow properties, so it can be easily applied yet stays in place on surfaces to create a natural chemical barrier that is impenetrable to ants. Stability testing shows that the gel is heat stable, and does not melt or lose shape up to 210 degrees F. Outside exposure testing shows that the repelling action of the composition lasted for more than a year, even when exposed to rain, frost, and heat up to 115 degrees F.

A major advantage of this composition over other insect repelling compositions, is that it is completely safe to use around food, children, pets, and wild birds. This is because oleic acid is the primary component of edible oils such as canola or olive oil, so it is already universally consumed. And, fumed silica along with many other thickening agents are approved for use by the FDA as a food additives.

In one embodiment of the present invention, the composition is a fatty acid combined with a thickening agent, and optionally a functional additive, to form a non-toxic ant-repelling gel.

In one embodiment of the present invention, the composition is a fatty acid combined with a thickening agent, and optionally a functional additive, to form a non-toxic ant-repelling gel, used to protect wild bird nectar feeders from ants or insects.

In one embodiment of the present invention, the composition is a monounsaturated oil combined with a thickening agent to form a non-toxic ant-repelling gel.

In one embodiment of the present invention, the composition is oleic acid combined with a thickening agent to form a non-toxic ant-repelling gel.

In one embodiment of the present invention, the composition is oleic acid combined with a thickening agent, and optionally a functional additive, to form a non-toxic ant-repelling gel, used to protect wild bird nectar feeders from ants or insects.

In one embodiment of the non-toxic ant-repelling gel, the thickening agent is a high viscosity wax such as bee's wax.

In one embodiment of the non-toxic ant-repelling gel, the thickening agent is an oleophilic polymer.

In one embodiment of the non-toxic ant-repelling gel, the thickening agent is an oil-miscible gelling agent such as Carbopol by Lubrizol Corp.

In one embodiment of the non-toxic ant-repelling gel, the thickening agent is a clay.

In one embodiment of the non-toxic ant-repelling gel, the thickening agent is silicon dioxide.

In one embodiment of the non-toxic ant-repelling gel, the thickening agent is a silica selected from the group consisting of fumed silica, precipitated silica, silica gel, alpha quartz, diatomaceous earth, nano silica and combinations thereof.

In one embodiment of the non-toxic ant-repelling gel, the thickening agent is a clay.

In one embodiment of the non-toxic ant-repelling gel, the thickening agent has physical properties irritating to ants such as fumed silica, silica gel, precipitated silica, alpha quartz, diatomaceous earth, and combinations thereof.

In one embodiment of the non-toxic ant-repelling gel, the thickening agent is a silicone-treated fumed silica.

In one embodiment of the non-toxic ant-repelling gel, the composition is a fatty acid combined with a thickening agent, enclosed within packaging means.

In one embodiment of the present invention, the composition is a fatty acid combined with water and an emulsifying surfactant to form a non-toxic ant-repelling emulsion.

In one embodiment of the present invention, the composition is a fatty acid combined with water and an emulsifying surfactant to form a non-toxic ant-repelling emulsion used to protect wild bird nectar feeders from ants or insects.

In one embodiment of the present invention, the composition is a monounsaturated oil combined with water and an emulsifying surfactant to form a non-toxic ant-repelling emulsion.

In one embodiment of the present invention, the composition is oleic acid combined with water and an emulsifying surfactant to form a non-toxic ant-repelling emulsion.

In one embodiment of the present invention, the composition is oleic acid combined with water and an emulsifying surfactant to form a non-toxic ant-repelling emulsion used to protect wild bird nectar feeders from ants or insects.

In one embodiment of the non-toxic ant-repelling emulsion, the emulsifier is a non-ionic surfactant.

In one embodiment of the non-toxic ant-repelling emulsion, the emulsifier is an anionic surfactant.

In one embodiment of the non-toxic ant-repelling emulsion, the emulsifier is a cationic surfactant.

In one embodiment of the non-toxic ant-repelling emulsion, the emulsifier is a combination of non-ionic, anionic, and cationic surfactants.

In one embodiment of the non-toxic ant-repelling emulsion, silica-based additives are added such as fumed silica, silica gel, precipitated silica, alpha quartz, diatomaceous earth, and combinations thereof.

In one embodiment of the non-toxic ant-repelling emulsion is enclosed within packaging means.

One embodiment of the present invention is a kit for repelling and blocking ants comprising: (i) a non-toxic ant-repelling gel, comprising: (a) a fatty acid, (b) a thickening agent to increase viscosity, (c) optionally, a functional additive; (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) a fatty acid, (b) a thickening agent to increase viscosity, (c) optionally, a functional additive; and (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) a fatty acid, (b) a thickening agent to increase viscosity, (c) optionally, a functional additive; (d) optionally, packaging means; and (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) oleic acid, (b) a thickening agent to increase viscosity, (c) optionally, a functional additive; (d) optionally, packaging means; and (ii) instruction means for applying said ant repelling gel.

One embodiment of the present invention is a kit for repelling and blocking ants from accessing a wild bird nectar feeder, comprising: (i) a non-toxic ant-repelling gel, comprising: (a) oleic acid, (b) fumed silica, (c) optionally, a functional additive; (d) optionally, packaging means; and (ii) instruction means for applying said ant repelling gel.

One embodiment of the present invention is a kit for repelling and blocking ants, wherein the fatty acid is a monounsaturated oil.

One embodiment of the present invention is a kit for repelling and blocking ants, wherein the fatty acid is oleic acid.

One embodiment of the present invention is a kit for repelling and blocking ants, wherein the fatty acid is oleic acid, and is the primary component of a natural vegetable oil such as sunflower oil, olive oil, or canola oil.

One embodiment of the present invention is a kit for repelling and blocking ants, wherein the thickening agent is a selected from a group consisting of high viscosity wax, an oleophilic gelling agent, copolymers of acrylic acid, high surface area thickeners, clay, precipitated silica, diatomaceous earth, fumed silica, surface-treated fumed silica and combinations thereof.

One embodiment of the present invention is a kit for repelling and blocking ants, wherein the thickening agent also has physical properties irritating to ants such as fumed silica, silica gel, precipitated silica, alpha quartz, diatomaceous earth, and combinations thereof.

One embodiment of the present invention is a kit for repelling and blocking ants, wherein the thickening agent is fumed silica.

One embodiment of the present invention is a kit for repelling and blocking ants, comprising a non-toxic ant-repelling gel, dispensed through a syringe as a line of gel.

One embodiment of the present invention is a kit for repelling and blocking ants, wherein the packaging means is selected from a group consisting of a syringe, a flexible squeeze tube, a squeeze tube, a caulking gun, a paste dispenser, a can, a bottle, a spray bottle, a bag, a pouch, a packet, tube, and combinations thereof.

One embodiment of the present invention is a kit for repelling and blocking ants, wherein the packaging materials are selected from a group consisting of plastic, glass, metal foil, mylar, nylon, paper, and composite combinations thereof.

One embodiment of the present invention is a kit for repelling and blocking ants, comprising: (i) a non-toxic ant-repelling emulsion, comprising: (a) a fatty acid, (b) water, (c) an emulsifier, (d) optionally, a functional additive; (ii) instruction means for applying said ant repelling emulsion.

One embodiment of the present invention is a kit for repelling and blocking ants, comprising: (i) a non-toxic ant-repelling emulsion, comprising: (a) oleic acid, (b) water, (c) an emulsifier, (d) optionally, a functional additive; (e) packaging means (ii) instruction means for applying said ant repelling emulsion.

One embodiment of the present invention is a kit for repelling and blocking ants from accessing a wild bird nectar feeder, comprising: (i) a non-toxic ant-repelling emulsion, comprising: (a) oleic acid, (b) water, (c) an emulsifier, (d) optionally, a functional additive, (e) packaging means; (ii) instruction means for applying said ant repelling emulsion.

One embodiment of the present invention is a kit for repelling and blocking ants, comprising a non-toxic ant-repelling emulsion, wherein the fatty acid is a monounsaturated oil.

One embodiment of the present invention is a kit for repelling and blocking ants, comprising a non-toxic ant-repelling emulsion, wherein the fatty acid is oleic acid.

One embodiment of the present invention is a kit for repelling and blocking ants, comprising a non-toxic ant-repelling emulsion, wherein the fatty acid is oleic acid, and is the primary component of a natural vegetable oil such as sunflower oil, olive oil, or canola oil.

One embodiment of the present invention is a kit for repelling and blocking ants, comprising a non-toxic ant-repelling emulsion, dispensed as a spray though a spray bottle.

One embodiment of the present invention is a kit for repelling and blocking ants, comprising a non-toxic ant-repelling emulsion, within packaging means selected from a group consisting of a syringe, a squeeze tube, a caulking gun, a paste dispenser, a can, a jar, a bottle, a spray bottle, a bag, a pouch, a packet, and combinations thereof.

For a better understanding of the invention reference is made to the following detailed description of the alternate embodiments thereof which should be taken in conjunction with the prior described drawings.

### BRIEF DESCRIPTION OF THE DRAWINGS

FIG. 1A (prior art) shows the chemical structure of oleic acid.

FIGS. 1B-1D show the chemical reaction steps that result in an increase in viscosity of oleic acid gel 100 due to oxidation and polymerization.

FIGS. 2A-2B show an oblique view and top view the ant-repelling gel tape 200 of the present invention.

FIG. 2C shows the ant-repelling gel tape 200 of the present invention applied to a pole 90 or other object.

FIG. 3A shows a method of use of the ant-repelling gel 100 of the present invention applied to a pole 80 with a hummingbird feeder 70 suspended therefrom.

FIG. 3B shows a method of use of the ant-repelling gel tape 200 of the present invention applied to a pole 90 with a hummingbird feeder 70 suspended therefrom.

FIG. 4A (prior art) shows a strip of hook and loop-type carrier material or fabric 40.

FIG. 4B shows the ant-repelling gel 100 of the present invention applied to a strip of hook and loop-type carrier material or fabric 40.

### DETAILED DESCRIPTION OF THE INVENTION

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

Fatty Acid

A fatty acid is a carboxylic acid with a long aliphatic tail (chain), which is either saturated or unsaturated.

Monounsaturated Oil

A monounsaturated oil is a chemical compound that contains a single carbon-carbon double bond, such as those found in alkenes. Monounsaturated edible oils are non-toxic and considered a healthy oil alternative.

Oleic Acid

Oleic acid is a fatty acid that occurs naturally in various animal and vegetable fats and oils. Oleic acid is classified as a monounsaturated omega-9 fatty acid. The term “oleic” means related to, or derived from, oil or olive, the oil that is predominantly composed of oleic acid.

Thickening Agent

Thickening agents are additives which increase the viscosity of fluids. The mechanism of thickening can vary, and includes the flow-inhibiting properties of long polymers, high surface area material, high viscosity material or cross-linking agents. Examples include but are not limited to copolymers of acrylic acid (such as Carbopol™), natural gums, waxes, and polyacrylamide. Examples of high surface area materials are fumed silica, precipitated silica and clays, and create thickening by restricting the flow properties of the fluid. Clays can include but are not limited to montmorillonite, bentonite, kaolinite, fullers earth, or hectorite,

Emulsifier

An emulsifier, is a substance that increasing the stability of an intimate blend of two or more immiscible phases. Emulsifiers are often also surfactants or “surface active agents. The surfactants employed in this invention can be anionic, cationic, non-ionic or combinations of each. Some examples of emulsifiers are cetearyl alcohol, polysorbate 20, and ceteareth 20.

Functional Materials

Functional materials that may further be combined with the present inventive compositions include coloring agents and fragrance. Additional functional materials include, but are not limited to, anti-microbial agents, anti-molding agents, odor absorbers, rheology modifiers, spoilage indicators, and flavorants. The functional materials may be present in any desirable weight percent with respect to the ant repelling composition.

Nectar Feeder

A wild bird nectar feeder 70 is a device designed to dispense or display liquid food 72, giving access of the food to birds, especially hummingbirds and orioles. Examples of nectar feeders 70 are inverted feeders and saucer feeders. An inverted feeder has a central reservoir that is suspended over the feeding ports and releases nectar 72 from above. The effects of vacuum keep the nectar 72 from flowing freely out the ports, keeping the ports filled at optimum levels. Inverted feeders can be top filling or bottom filling style. A saucer feeder is a simple dish filled with nectar 72 that has ports above the reservoir, allowing birds to dip their bills into the nectar supply 72. A nectar feeder 70 can be as simple as an inverted glass bottle with a tube at the bottom, or as complicated as a multiple feeding-port feeder. They all have in common a reservoir to hold the nectar 72, and feeding ports which restrict the free flow of the nectar out of the feeder 70 while providing nectar access to the hummingbirds and orioles.

Coloring Agent

A coloring agent may also be added to enhance the aesthetic nature of the ant blocking gel 100. However, a coloring agent is not necessary. Coloring agents include, but are not limited to dyes, pigments, and polymeric colorants. Non-limited examples of dyes include acid blue 9 dye, methylene blue, and wool violet. Examples of pigment are hematite, Cu-phthalocyanine or Ultramarine blue. Examples of polymeric colorants are various products under the Liquitint™ name produced by Milliken Chemical.

Packaging Means

Suitable impermeable packaging means include, for example, but are not limited to containers of glass, plastic, foil, mylar, paper, waxed paper, and other materials known in the art for storing and dispensing liquid products. Other suitable impermeable packaging means include but are not limited to containers or film composed of polyvinylchloride (PVC), cellulose, cellophane, vinyl, nylon, thermoplastics, silicones, polyethylene, polypropylene, or combinations thereof. Suitable packaging means include, but are not limited to a syringe, a squeeze tube, a caulking gun, a paste dispenser, a can, a jar, a bottle, a spray bottle, a bag, a pouch, a packet, and combinations thereof.

### EXAMPLES

### Example 1

Ten grams of fumed silica (Cab-O-Sil, Cabot Corporation) are blended together with 140 grams of oleic acid. The fumed silica possesses a high surface area, and the oleic acid is a low viscosity fluid, and as the particles are dispersed in the oil they inhibit the free-flow of the oil. Simple mixing creates a thickening action that results in a clear gel 100.

Physical property testing reveals that the gel 100 is shear-thinning, so it is easily applied, yet stays in place on surfaces. Testing shows that the gel 100 is heat stable, and does not melt or lose shape up to 210 degrees F. The gel is also water-resistant, and therefore can stand up to the heat and rain outdoors.

The composition was tested via two applications methods on nectar feeders 70 that had already been invaded by ants 60 with a heavy ant trail: a) applying a thin line of gel around a hook holding a feeder and b) applying a thin line of gel 100 on a pole 80 supporting a feeder 72. Application resulted in immediate blocking of the ants 60, and no ant ever crossed the line again. Over time the gel 100 thickens to become more waxy, but still repels ants. The repelling action of the composition and the protection of the feeders lasted for more than a year, exposed to rain, frost, and heat up to 115 degrees F.

### Example 2

0.1 pounds of fumed silica (Cab-O-Sil, Cabot Corporation) is blended together with 1.5 pounds of oleic acid, and 0.001 pounds of cinnamon oil as a fragrance. A portion of the blend 100 is placed into a syringe. The syringe is compressed to emit a line of gel around a pole 80 supporting a nectar feeder 70.

Self-Hardening Nature of Ant Repellent Gel 100

One simple embodiment of the invention is the addition of fumed silica with oleic acid oil. The fumed silica increases the viscosity of the oil due to the small size of the fumed silica particles, the branched structure of the fumed silica particles, and the arrangement of the particles into a temporary structural network that thickens the liquid into a self-supporting gel 100.

In order to easily apply the repellant gel 100 to a surface, a user may want the gel to have a paste-like consistency, i.e., a viscosity similar to caulk or tooth paste, so that it can be extruded, spread and will stick when applied to a surface. But after the gel 100 is applied, a user would want the gel to be firmer and more durable, so that it is more resistant to harsh weather and inadvertent displacement.

One of the novel advantages of using the current invention of repellent gel 100 as barrier, is that after it is applied as a soft gel to a surface, it slowly hardens to become more durable. For example, the viscosity of the gel of the present invention when it is first applied to a surface has the flow properties of about 100,000 centipoise, i.e., about that of toothpaste. After several weeks exposed to the environment the gel has the flow properties of about 500,000 centipoise, i.e., about that of lard at room temperature, and progresses over time to eventually have the viscosity of wax. Even after it has become more tough it is still effective at repelling since it still retains a substantial amount of free oleic acid. This unique behavior occurs by a process of polymerization, which turns the gel into a harder gel when the gel is exposed to outside conditions which includes exposure to oxygen. This increase in durability after exposure has a novel advantage over other methods, and apparently does not occur in other repellent formulas that contain oleic acid.

The chemical process of polymerization and durability that occurs in the gel formulation of the present invention, is most simply described as oxidation, initiated by oxygen in the air and the high surface area of the fumed silica, which results in polymerization of the oleic acid. When combined in formulations of the present invention, exposure to air adds an oxygen atom to the carbon-hydrogen bonds adjacent to the double-bond within the oleic acid carbon chain. This creates a hydroperoxide functional group on the oleic acid carbon chain. This hydroperoxide group is susceptible to crosslinking reactions with other oleic acid chains. This crosslinking of the chains results in oligomerization and polymerization of the oleic acid, and a resulting increase in viscosity, eventually to a waxy consistency. This reaction does not occur to a solution of oleic acid alone when exposed to air, at temperatures normally encountered in nature, but is seen in the formulation of the present invention.

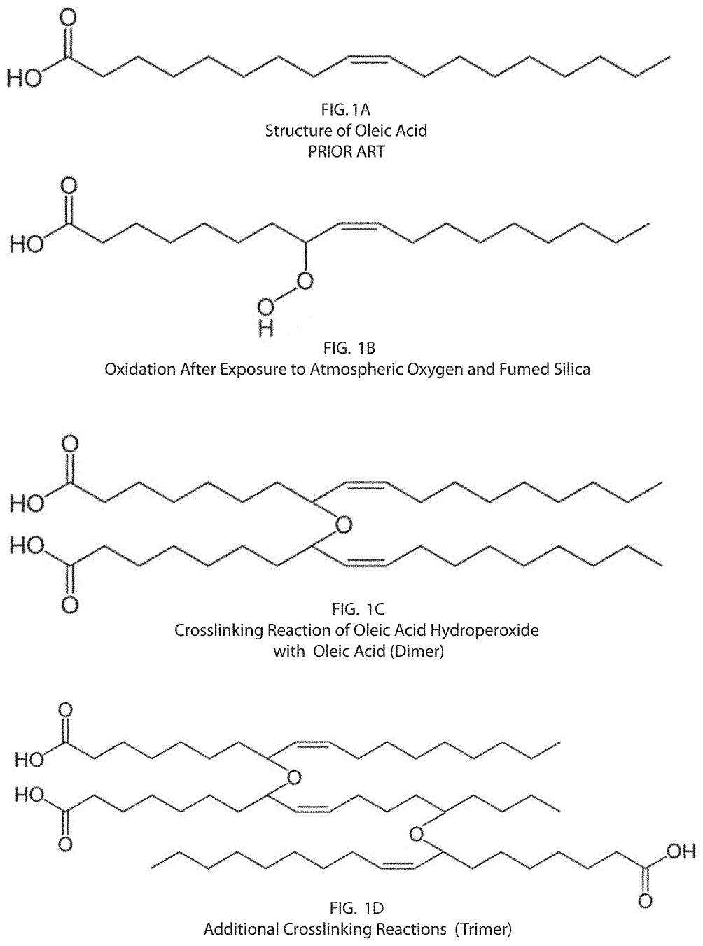

FIG. 1A (prior art) shows the structure of oleic acid. As shown in FIG. 1A, oleic acid contains an 18 carbon chain with a single double bond in the middle. When the oleic acid is combined with fumed silica in formulations of the present invention, the exposure to air, and the high surface area of the silica, results in oxidation of the oleic acid.

FIGS. 1B-1D show the chemical reaction steps that result in an increase in viscosity of oleic acid gel 100 due to oxidation and polymerization.

The durability that develops in the oleic acid gel 100 of the present invention, is most simply described as slow polymerization, initiated by the interaction between the 1) oleic acid, 2) the high surface of the fumed silica, and 3) oxygen in the air.

FIG. 1B shows an initial reaction after exposure to oxygen. After exposure to atmospheric oxygen and the high surface area of the fumed silica, some of the oleic acid in the gel 100 is oxidized, forming a hydroperoxide group on the oleic acid chain As shown in FIG. 1B, this oxidation results in an oxygen atom, and subsequently an hydroperoxide group attaching to the carbon-hydrogen bonds adjacent to the double-bond within the carbon chain. This hydroperoxide group is susceptible to crosslinking reactions with other oleic acid molecules.

FIG. 1C shows the result of a crosslinking reaction between the hydroperoxide and another oleic acid molecule, resulting in an oleic acid dimer.

FIG. 1D shows additional crosslinking reactions with other oxidized oleic acid molecules that create further polymerization. The oleic acid trimer is shown in FIG. 1D. This reaction sequence slowly continues to bond together larger oligomers and polymers of oleic acid resulting in an increase in viscosity, and eventually to the gel having a waxy consistency. This reaction does not occur in a solution of oleic acid alone when exposed to air, at temperatures normally encountered in nature, but is seen in the formulation of the present invention.

Although spontaneous polymerization of oleic acid does not occur with oleic acid alone (separate from the present invention), a spontaneous reaction can be seen in polyunsaturated oils, which help explain what is happening with oleic acid. Oils that spontaneously polymerize and “harden” are commonly known as a “drying oils”. Typical “drying oils” like linseed oil or tung oil, have multiple double bonds (high iodine value), and spontaneously oxidize and polymerize at room temperature. Oleic acid is considered a “non-drying oil”, due to its single double bond (low iodine value), and does not spontaneously oxidize or polymerize at room temperature to any significant degree.

Years of observation in our labs, and data from the chemical literature show that there is no substantial increase in viscosity (polymerization) of oleic acid bulk liquid when it is exposed to air and to temperatures normally encountered in the environment, and therefore the oleic acid doesn't rapidly auto-oxidize on its own, and must have an additional component to initiate the oxidation and the resulting polymerization. Years of observation in our lab has also shown that there is no substantial increase in viscosity in gel combining the oleic acid and fumed silica, when the gel is kept in its protective air-tight packaging, and therefore the gel must have exposure to air to initiate the crosslinking and polymerization. Surprisingly, we observe that the gel of the invention that contains both components (oleic acid and fumed silica) does increase in viscosity when it is exposed to air. We can conclude that it is the addition of fumed silica to the oleic acid formula which is responsible for promoting this polymerization reaction. These scenarios are listed in Table 1, and show the conditions which must be available for the oleic acid to polymerize, and shows that both the presence of fumed silica and exposure to air must occur for polymerization to happen. Based on chemical fundamentals we theorize that it is the fumed silica's high surface area that acts as the catalyst to increase the reaction between the oleic acid and oxygen in the air to promote oxidation, resulting in cross-linking, resulting in polymerization, resulting in an increase in viscosity and hardening. Since only some of the oleic acid molecules participate in this polymerization reaction, the rest of the oleic acid in the gel formulation is free to still act as an effective repellent.

Substantial polymerization only occurs with presence of fumed silica and exposure to air

TABLE 1

| | Condition 1 | Condition 2 | Condition 3 |
|---|---|---|---|
| Oleic Acid | Present | Present | Present |
| Fumed Silica | Absent | Present | Present |
| Exposure to Air? | Yes | No | Yes |
| | | (still in tube) | |
| Polymerization | No | No | Yes |

An additional advantage of this invention, is that unlike other ant repellents, it is inherantly safe for hummingbirds. The reason, is that the primary ingredient is one that hummingbirds already secrete to condition their feathers. Oleic acid is one of the major fatty acids secreted from a bird's preening oil gland (uropygial gland). It is this oily secretion from the uropygial gland that birds use for preening and maintaining their feathers. “Physiological and Biochemical Aspects of the Avian Uropygial Gland” states: “The fatty acid composition of the lipids extracted from the gland secretion consisted of C14 to C20 chains, most of which were unsaturated, with a prevalence of oleic acid . . . .” Saliba, A. and Montali D., Braz. J. Bio. (2009) 69 (2) 427-446).

In other words, if a bird were to accidentally come in contact with the product 100, it contains a chemical common in preen oil that the birds already use to preen and condition their feathers naturally, and therefore inherently safe. The formula is also non-toxic. In addition, the formula is not tacky, so there is not risk that a hummingbird's feathers might become attached. And after time the gel becomes more viscous and resists physical contact while still remaining repellent.

Since the viscosity of this gel is not affected by temperature, it keeps its integrity on hot days, and it does not melt even when tested on a pole at exposed to all-day summer sun on a 118 degrees F. day based on actual field testing in Brentwood, Calif. Also, since the gel formula is based on a oil, it exhibits water repellency, and is resistant to rain and other weather conditions. However, this repellency can be improved with the proper selection of fumed silica. Regular untreated fumed silica, such as Cabot M-5, contains particles with a silicon oxide surface. In the absence of oil, such a surface is hydrophilic, in that it has an affinity for water. When the gel is newly applied, and then exposed continuously to water, such as several days of rain, the fumed silica can absorb some water and effect the integrity of the gel. Apparently, some moisture can migrate beneath the oil to be absorbed on the hydrophilic silica surface. This does not happen often, but it can happen. There is an improvement to the formula which avoids this from happening, and creates a gel which is truly weather-proof over a long period. If the gel is created by using a fumed silica whose particles have a hydrophilic surface (such as Cabot TS-720, which is actually superhydrophobic), then the silica particles have no affinity for water, and will be truly weatherproof over a long period of time.

Ant Repellent Tape

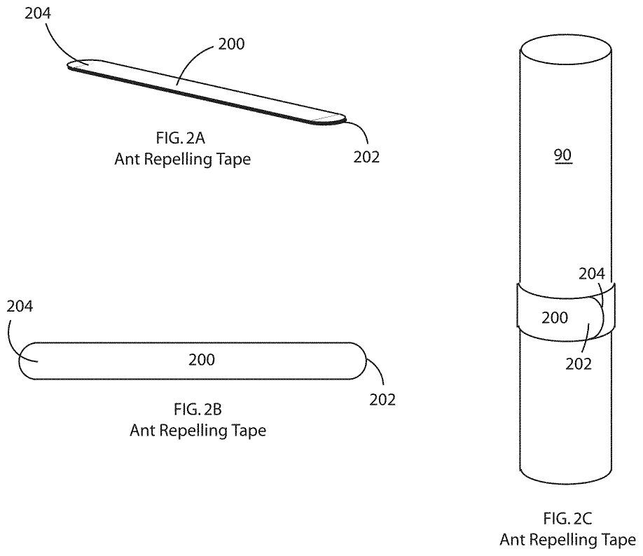

FIGS. 2A-2B show an oblique view and top view the ant-repelling gel tape 200 of the present invention.

The ant-repelling gel tape 200 of the current invention possesses a form that allows it to easily wrap around objects to block and repel ants. Such a form generally has a small height, a medium width, and a long length. One embodiment of the ant tape 200 possesses a height of 0.01 to 0.25 inches, a width of 0.1 to 3 inches, and a long length that can range from 3 inches to 60 inches. Another embodiment of the ant tape 200 before being applied can be an entire roll of tape up to hundreds of yards in length.

The 2 ends 202 and 204 of the tape 200 can be attached together or attached separately to any object 90 whether it is a pole, a wall, a fence, a tree, pet feeding containers, etc., basically anything that might attract ants 60.

FIG. 2C shows one embodiment of the use of the ant tape 200 wrapped around a pole 90, to block and repel ants 60 from traveling to bird feeders 70, bird houses or any other objects supported by the pole 90.

An additional embodiment of the ant repelling gel composition 100 of the present invention takes the form of a solid tape product 200. The solid ant-repelling tape 200 of the present invention can be wrapped on or around an access point or other object that ants are using as pathway to pass from one point to another. One embodiment of the present invention takes the physical form of a tape that has an adhesive bottom layer that sticks to materials and objects, and sticks to itself if wrapped around an object, i.e., the ant-repelling tape is wrapped onto itself.

Another embodiment of the ant-repelling tape 200 of the present invention is an ant-repelling tape that does not have an adhesive bottom side, but fuses with itself, allowing it to stick to a previous layer of tape if wrapped around an object, or if applied as overlapping strips, the end of one strip fusing to the next.

In the present invention, the term tape is defined as a material or object which possesses a small height, a medium width, and a long length. The long direction can also be circular, such as in the form of a band. The tape of the present invention can also be referred to as a strip, flat section or sectional, layer, ribbon or band of material. It can be made of various materials, and can be produced by various methods. The main value of its shape is that it can be placed on surfaces or wrapped around objects in order to block the path of ants moving from one point to another.

Increasing the Viscosity of a Gel Using Polymers to Form a Tape Composition

Materials and methods for creating the high viscosity gel tape of the present invention using oleic acid involve the use of additional polymers. Increase in viscosity of the ant-repelling gel of the present invention occurs when the long carbon chains and branches of the added polymer molecules entangle, inhibiting movement of the liquid, thus forming a high viscosity gel that can be produced in the form of a tape. This increase in viscosity, is also commonly called thickening. Examples of polymers which can be used to form a high viscosity gel tape are polyurethanes, acrylic polymers, latex, styrene/butadiene, polyvinyl alcohol, methyl cellulose (CMC, HMC, HPMC), organosilicones, silicone rubber, silicone resins, and modified silicones. The polymer chains can also link together at certain points in the middle of their polymer chains in a process called crosslinking, which further increases viscosity. With enough polymer entanglement or crosslinking, a compound is formed that is viscous enough to resist deformation when force is applied, and hence is described as elastic. In any of the examples above, the oil is present as a liquid organic phase entrapped in a three-dimensionally polymer network, and is considered an organogel.

One might also want to use a polymer to produce a medium viscosity gel (50,000 to 500,000 centipoise). If a relatively smaller amount of polymer is added to the ant-repelling formulation of the present invention, the resultant gel will deform when a force is applied to it, and stay in that deformed shape. Thus, the ant-repelling gel of the present invention could be produced using polymers, which would be described as deforming plastically in response to a force, similar to the oleic acid and fumed silica formulation.

If a larger amount of polymer is used in the ant-repelling formulation of the present invention, or the amount of crosslinking is increased, a very high viscosity gel can be made which deforms when a force is applied to it, but returns to the original shape when the force is removed. Thus, another embodiment of the ant-repelling gel of the present invention is described as deforming elastically in response to a force. In regards to the ant-repelling gel of the present invention, the elastic gel polymer of the present invention is a gel since it is a liquid medium trapped within a three-dimensional cross-linked network. Beside the polymers mentioned above, other types of polymers can also be used to form the gel of the present invention, such as polyethylene, polypropylene, silicone rubber, etc.

The ant-repelling gel tape 200 of the current invention can be formed using a high viscosity organogel that can be plastically deforming or elastically deforming. These higher viscosity organogels as used in the formulations of the present invention are an improvement and alternative embodiment to the soft spreadable ant-repelling gel of the present invention using fumed silica described previously for the following reasons:

First, the ant-repelling gel tape 200 of the present invention is more durable, so that forces that it may encounter in everyday use, such as high velocity rain/hail or wild animals will not deform it or decrease its effectiveness.

Second: The ant-repelling gel tape 200 of the present invention is less transferable. Because it cannot be transferred by accidental or unintended contact, it is less messy, and safer for use for humans, birds or pets.

Third: The ant-repelling gel tape 200 of the present invention is easier to apply.

Fourth: The ant-repelling gel tape 200 of the present invention can be packaged in a variety of ways.

Polymer formation or crosslinking for thickening the ant-repelling gel tape 200 of the present invention can be initiated in a variety of ways. These methodologies are well known in polymer chemistry, and described or covered under the chemical subjects of step-growth polymerization or chain growth polymerization.

One embodiment of the ant-repelling gel tape 200 of the present invention is the use of silicone-based polymers to form the gel. Silicone polymers have the advantage of being available in a variety of formations and crosslinking strategies. These types of polymers are also durable under exterior or outside conditions of temperature, moisture, UV exposure and other environmental conditions. In alternate embodiments, the silicone polymers of the ant-repelling gel tape 200 of the present invention can be 2-part silicones polymerized or crosslinked by platinum, tin or other catalysts. In additional alternate embodiments, the polymers used in the ant-repelling gel tape 200 of the present invention can be 1-part silicones that are polymerized or crosslinked by moisture or exposure to air, such as room temperature vulcanizing (RTV) silicones. Other silicones can be cured by temperature.

One embodiment of the ant-repelling gel tape 200 of the present invention is a tape that sticks well to a surface or to itself, to facilitate wrapping around a pole, tree or other object. Therefore, one embodiment of the current gel tape invention is a composition designed so that polymerization is incomplete, and the tape retains a tacky surface. Another embodiment of the ant-repelling gel tape is a composition in which an adhesive polymer which does not cure, i.e., polymerize or cross-link, is added to the composition, to create a tacky surface on the tape. Alternatively, there are tacky silicone compounds which may be added to the polymer to enhance its self-adhesive properties.

Additional additives may be added to the organogel composition ant-repelling gel tape 200 of the present invention which can enhance the physical or aesthetic properties of the gel. Solvents additive may be used to lower the viscosity of the uncured organogel composition ant-repelling gel tape 200 allowing it to be self-leveling in a mold. Pigment additives may be used to color the polymer used in the ant-repelling gel tape 200 to match specific situations. Fragrance additives may be used to make the ant-repelling gel tape 200 more aesthetically pleasing. Other additives may be used to create a long-term tacky surface to enhance attachment of the ant-repelling gel tape 200.

The ant-repelling gel tape 200 of the present invention is an efficient use of oleic acid. The percentage of free oleic acid in a formula of the ant-repelling gel tape 200 may vary widely, depending upon how it is incorporated into the gel. For example, if the ant-repelling gel 100 is simply a thickened oil, embodiments of the invention can contain from 30% to >99% oleic acid. However, if the gel is a polymer structure, like silicone, in the form of a tape, the ant-repelling gel tape 200 can be formulated with much less oleic acid, and contain from as little as 0.5% to up to only 30% free oleic acid. Thus, using a polymer in the ant-repelling gel tape 200 of the present invention provides the advantage that it is a more efficient use of the oleic acid for purposes of repelling ants.

In order to process the ant-repelling gel tape 200 of the present invention into the shape of a tape, several possible methods include but are not limited to (1) extruding the ant-repelling gel tape through a flat die, (2) pressing a flow of ant-repelling gel formula through compressing rollers, and (3) pouring the gel tape formulation into a mold.

An additional embodiment of the ant-repelling gel tape 200 of the present invention is the use of a pre-formed solid polymer tape-shaped material which has an open-cell microporous structure, able to absorb the oleic acid. The oleic acid and preformed tape are combined, and the oleic acid is absorbed into the tape or applied to the surface of a carrier material to create the organogel ant-repelling gel tape 200 of the present invention. In addition, in order to increase the viscosity of the oleic acid to avoid gradual loss of the oleic acid out of the polymer pores, a thickening agent can be pre-mixed with the oleic acid before being absorbed into the pre-formed polymer tape-shaped carrier material. One non-limiting example of such a thickening agent would be fumed silica.

Embodiments of the ant-repelling organogel tape 200 of the present invention made using pre-formed solid polymer tape with free micropores can contain free oleic acid contents of from 0.1% to 50%.

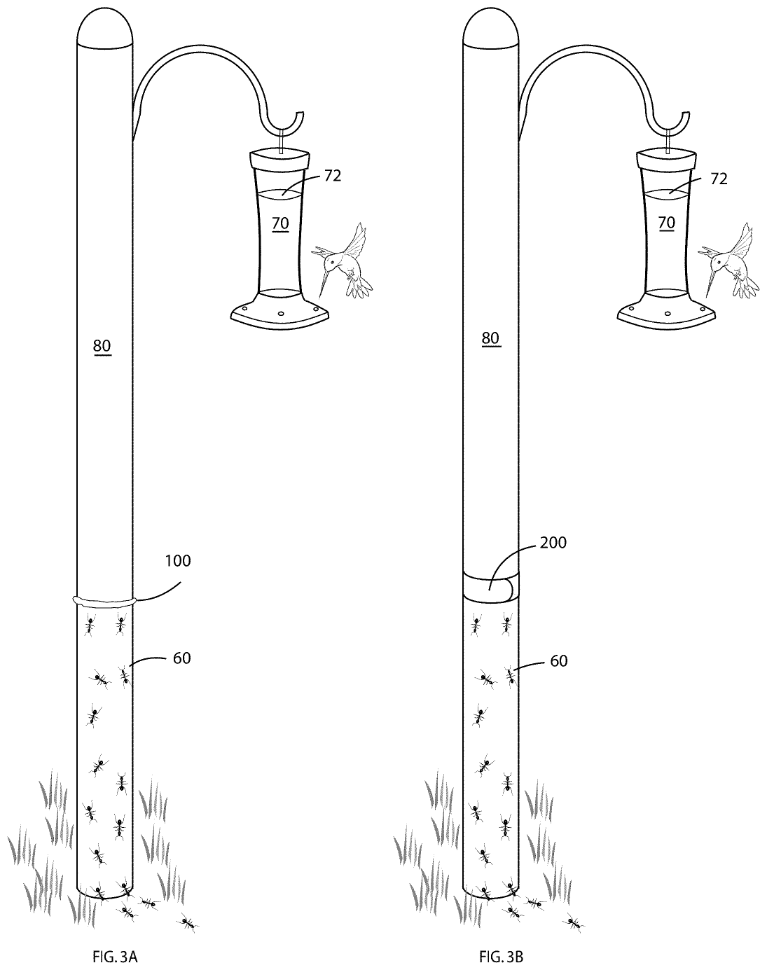

FIG. 3A shows a method of use of the ant-repelling gel 100 of the present invention applied to a pole 80 with a hummingbird feeder 70 suspended therefrom.

FIG. 3B shows a method of use of the ant-repelling gel tape 200 of the present invention applied to a pole 80 with a hummingbird feeder 70 suspended therefrom.

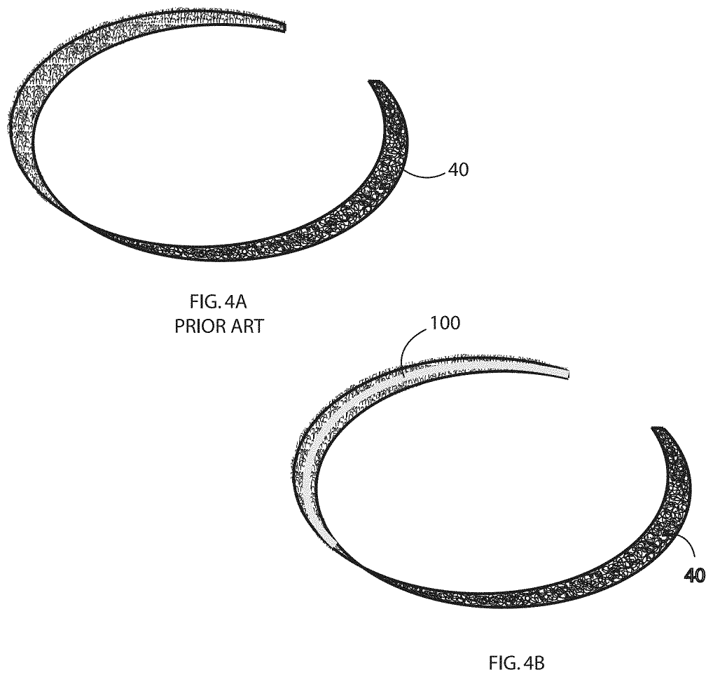

FIG. 4A shows a strip of hook and loop-type carrier substrate material or fabric 40 of the prior art. The carrier substrate or strip of material 40 can be also be other types of suitable substrate material, including but not limited to Velcro®, plastic or cellophane or fabric adhesive tape, material having snaps or buttons on opposing ends, etc.

FIG. 4B shows the ant-repelling gel 100 or tape 200 of the present invention applied to a strip of hook and loop-type carrier material or fabric 40.

An embodiment of the ant-repelling gel 100 or tape 200 of the present invention uses another type of pre-formed fabric or polymer material 40, referred to as hook and loop material, and often referred to under the trade name Velcro®. This type of fabric or material 40 consists of two types of surface, a surface made up of numerous J-shaped filaments which act as tiny plastic “hooks”, and a surface made up of felt-like fabric containing numerous “loops” of plastic tread. When the two types of surface are pressed together, the hooks grab the loops, holding the two surfaces together. The two hook and loop surfaces can be on different pieces of material, or, they can be on opposite sides of the same piece. Since the present invention will often be looped around on itself, this description will focus on the material 40 in which the hook and loop structures are on the opposite sides of the same tape 40. Since the strong bonding nature of this type of material 40 is provided by the physical “hook and loop” structure, this embodiment avoids the need for the invention to have a chemical adhesive or binding system. This type of material 40 can be combined with the invention in several ways.

One embodiment of using hook and loop material 40 is to combine it with another polymer organogel 100. In this case the polymer organogel 100 provides the repellent part of the invention, and the hook and loop material 40 provides a way of attaching the polymer organogel 100 around the object.

One embodiment of using the hook and loop material 40 is to combine it with a premade repellent gel 100, one non-limiting example being a gel made of oleic acid and fumed silica gel. If the gel 100 is simply spread on one or both sides of the hook and loop material 40, the tape 400 can then be looped around a pole or other structure and pressed to itself to strongly and permanently attach it. The non-bonded section of the tape provides the repellent surface, containing gel 100, and either the hook or loop surface of the tape 400. If the repellent 100 is placed on only one side of the tape 400, that side should be the one facing out when attached. Since the tape 400 is firmly against the surface, the ants must travel over the tape, encountering the gel.

The embodiment of the gel 100-infused hook and loop material 40 provides an additional advantage over using the gel 100 alone. The gel 100 can be infused within or simply applied to the top of the material 40. An advantage is that the gel 100 is protected from person or animal contact, since the gel 100 resides primarily between the hooks and loops, below the upper surface of the hook or loop texture. However, it is easily contacted by the ant 60 when it tries to walk across the barrier, since their legs are smaller than the gaps between the hooks or loops, and will not be able to avoid contact with the gel 100, providing a chemical repellency. And, on the scale of an ant 60, the rough detailed structure of the hook and loop material 40 serve as an additional physical obstacle to the ant 60.

Embodiments of the ant-repelling gel 100 of the gel tape 200 of the present invention can contain additives to enhance the aesthetics of the ant-repelling gel 100 or tape 200, including components such as but not limited to rheology modifiers, colorants, fragrances, printed designs, etc.

Experimental Results

Ant-Repelling Gel 100 and Gel Tape 200 Formula Examples

### Example 1

5 grams of fumed silica (Cab-O-Sil M-5 (hydrophilic surface), Cabot Corporation) were blended together with 95 grams of oleic acid. Simple mixing created a thickening action that resulted in a clear gel 100 that can be extruded out of a squeeze-tube. A line of gel 100 having the firmness or viscosity of pudding was applied to a feeder support pole. A nectar hummingbird feeder was hung on the support pole. Ants were repelled from climbing the pole, and the feeder and nectar were protected from ants. After one week the gel of the present invention had firmed up to the consistency of about toothpaste. Subsequently, after a month, the gel had firmed up to the consistency of lard, and with more time, to the consistency of wax. The gel continued to repel ants and resist wear from heat and rain for more than one year.

### Example 2

Thirteen grams of fumed silica (Cab-O-Sil TS-720 (hydrophobic), Cabot Corporation) were blended together with 87 grams of oleic acid. Simple mixing created a thickening action to the oleic acid oil that resulted in a clear gel that can be extruded out of a squeeze-tube. A line of gel having the firmness or viscosity of tooth paste was applied to a feeder support pole. A hummingbird nectar feeder was hung on the support pole. Ants were repelled from climbing the pole, and the feeder and nectar were protected from ants. The gel maintained its integrity even after several days of rain that occurred during the week. After one week exposed to environment the gel of the present invention had firmed up to the consistency of about peanut butter. Subsequently, over time the gel had firmed up to the consistency of wax. The gel continued to repel ants and resist wear from heat and rain for more than one year.

Ant-Repelling Gel Tape Formula Examples

### Example 3

In a 50 ml disposable polyethylene cup, add:

10 grams of silicone rubber base
2 grams of free oleic acid
3 grams silicone solvent (This lowers the viscosity and makes the formula self-leveling).
Mix then add 1 gram of silicone rubber curing agent
Mix thoroughly and pour into a mold

To form the ant-repelling gel tape of the present invention, use is made of a mold that is long, thin and flat. For this example, the mold was 1-inch wide×8 inches long and 3/16 inch deep. The thickness of the tape was determined by how much formula is poured into the mold. In one example, 3 grams of formula is used for each mold. The formula should have a low enough viscosity that it spreads to cover the bottom of the mold. If the viscosity is too high, the formula can be adjusted by adding more silicone solvent. This formula contained about 9% free oleic acid as made, and about 12% once cured and the solvent dissipated.

### Example 4

In a polyethylene container, add:

58.8% silicone rubber base (polydimethylsiloxane type)
8.8% free oleic acid
5.9% of silicone rubber curing agent (tin catalyst type)
8.8% free oleic acid
17.7% silicone solvent (cyclosiloxane type)

Mix thoroughly and pour into a flat mold

To form the ant-repelling gel tape of the present invention, use a mold that is long thin and flat. For this example, the mold was 1-inch wide×8 inches long and 3/16 inch deep. The thickness of the tape was determined by how much formula is poured into the mold. The formula was low enough viscosity that it spreads to cover the bottom of the mold. If the viscosity is greater than desired, the formula can be adjusted by adding more silicone solvent. This formula contained about 9% free oleic acid as made, and about 12% once cured and the solvent dissipated.

### Example 5

In a 50 ml disposable polyethylene cup, add:

10 grams of silicone adhesive (room temperature acetoxy cure)
1 gram free oleic acid
3 grams octamethyltrisiloxane silicone solvent (The solvent lowers the viscosity and makes the formula self-leveling.)

Mix thoroughly.

To form the ant-repelling gel tape of the present invention, the formulation was poured into a mold that was long thin and flat. The thickness of the tape was determined by how much formula is poured into the mold. The formula should be a low enough viscosity that it spreads to cover the bottom of the mold. If it is not, the viscosity of the formula can be reduced by adding more silicone solvent.

### Example 6

In a 100 ml disposable polyethylene cup, add:

4.5 grams of polydimethylsiloxane silicone rubber base
5.5 grams of silicone adhesive (room temperature acetoxy cure)
0.5 grams free oleic acid
5 grams octamethyltrisiloxane silicone solvent (The solvent lowers the viscosity and makes the formula self-leveling.)

Mix thoroughly and pour into a mold

To form the ant-repelling gel tape of the present invention, a mold that was long thin and flat was used. In this case, the mold was 1-inch wide×8 inches long and 3/16 inch deep. The thickness of the ant-repelling tape was determined by how much formula was poured into the mold. In this case 3 grams were used for each mold. The formula should be a low enough viscosity that it spreads to cover the bottom of the mold. If the viscosity is too great, adjust the formula by adding more OS-20 solvent. This formula contained 6.7% free oleic acid as made, and 8% free oleic acid once cured and the solvent dissipated.

### Example 7

A coil of 100 grams of microporous polymer tape with an open-cell structure was placed into a shallow container. Added—1 gram of oleic acid evenly to the tape, and allowed to absorb. Continued adding oleic acid, one gram at a time, until it was apparent that the ant-repelling gel tape of the present invention had reached its maximum absorbency limit.

### Example 8

An extruder with a thin flat extrusion die was prepared and readied for use.

Mix together:

80% silicone rubber base
12% free oleic acid
8% silicone rubber curing agent

Extruded the ant-repelling gel tape formulation of the present invention as long strips onto a moving bed. Waited to allow the strips to cure prior to handling.

### Example 9

A mixing extruder was used, and the following ingredients were input to the mixing chamber to the extruder from continuous feeders in a continuous process:

80% polydimethylsiloxane silicone rubber base
12% free oleic acid
8% silicone rubber very fast curing agent

An extruder that thoroughly mixes was selected, and then the ant-repelling gel tape formulation of the present invention was immediately extruded. A die about 1 inch wide and about 1/16 inch high was used. The extruded ant-repelling gel tape of the present invention was in the shape of long strips. This was best done as a continuous process. A waiting period of time was required after formation to handle the strips of ant-repelling gel tape of the present invention.

### Example 10

A oleic acid-fumed silica gel was prepared according to Example 1. A line of gel was placed along each side of a hook and loop double-sided tape. A roller was used to spread and press the gel into the hook or loop texture. The completed tape was placed around a pole possessing a hook for a bird feeder. A hummingbird nectar feeder was placed on the hook of the pole. Ants trying to get to the nectar were repelled. The tape protected the gel from physical contact, but continued to repel ants.

Ant Tape Usage Examples

### Example 11

A 5-inch strip of 1-inch wide ant-repellent gel tape of the present invention was wrapped around a pole with a heavy line of ants traversing the pole to get to sugar water at the top. The ants refused to cross the tape, when they touched it, they ran away and proceeded to frantically clean themselves. In under an hour the ants had abandoned trying to get to the sugar water, and left. Ants trapped above the tape that couldn't return jumped off the pole escaped by jumping or falling.

### Example 12

A strip of ant-repellent gel tape of the present invention was wrapped around a tree branch with a hummingbird nectar feeder hanging on the end. A very active line of ants were traversing the branch to reach the feeder. The ants refused to cross the tape, if they touched it they then ran away and proceeded to clean themselves. The feeder was cleaned and refilled, and the ants on the feeder side of the tape were removed. The ants abandoned the branch, and stopped trying to access the feeder. The tape continued to repel ants and stay on the pole for more than a year.

### Example 13

A strip of ant-repellent gel tape of the present invention was wrapped around the trunk of a small orange tree that had been invaded with ants. The ants refused to cross the tape. Ants trapped above the tape that couldn't return jumped or fell off the tree. By the end of the day, the ants had left the tree and didn't return. The tape stayed on the tree and continued to repel ants for more than two years.

### Example 14

Two 12-inch strips of ant-repellent gel tape of the present invention were wrapped around a dog dish containing dog food, and placed in an outside patio area with active ants. The ants refused to cross the tape. If they touched it, they ran away and proceeded to frantically clean themselves. The dog food was protected indefinitely from ants invading the bowl.

Any of the example formulas of the ant-repellent gel tape described above can be used in a variety of situations to block ants. The following examples are a partial list of possible uses, and are in no way meant to limit the vast number of total possible uses.

### Example 15

Bluebird nests are susceptible to invasion by ants, because the ants attack and harm the bluebird hatchlings. The ant-repellent gel tape of the present invention was wrapped around a pole supporting a bluebird nest, where young bluebirds are vulnerable to attack by ants. The tape repelled the ants and blocked them from attacking the hatchlings.

### Example 16

Beehives are susceptible to attack by ants. An 8-inch strip of ant-repellent gel tape of the present invention was wrapped strips around the legs of a beehive to block ants from attacking the hive. The ants were blocked and repelled from accessing the beehive.

### Example 17

Strips of ant-repellent gel tape of the present invention were wrapped around the legs of a picnic table to block ants while camping

### Example 18

The ant-repellent gel tape of the present invention can be wrapped around the ankle section of a pair of boots to keep ants from coming up the user's legs when gardening, fishing or hunting.

In all of these examples, ants approaching the ant-repellent gel tape of the present invention are repelled by the scent of oleic acid. The height of the tape provides an additional physical barrier, and puts the oleic acid at face level with the ant magnifying its sensory effect.

Because the oleic acid in the ant-repellent gel tape of the present invention is not bonded to the polymer structure, it slowly emanates from the polymer tape over time, working its way to the surface. This provides long-lasting repellency.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the alternate methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

I claim:

1. A method for safely blocking and repelling ants from invading hummingbird nectar feeders using a water-resistant gel composition non-toxic to hummingbirds, the method comprising the following steps:
Obtaining free oleic acid from monounsaturated oil;
Formulating a gel composition containing the free oleic acid and a thickening agent, the thickening agent selected from the group consisting of a high viscosity wax, an oleophilic gelling agent, a polymer, a copolymer of acrylic acid, a high surface area material, a clay, precipitated silica, diatomaceous earth, fumed silica, surface-treated fumed silica, silicone, silicon dioxide and combinations thereof such that the composition has the smell of dead ants;
Enclosing the gel composition within a packaging means selected from the group consisting of a syringe, a flexible squeeze tube, a squeeze tube, a caulking gun, a paste dispenser, a can, a bottle, a spray bottle, a bag, a pouch, a packet, tube, and combinations thereof;
Applying a layer of the gel composition from the packaging means in a contiguous band around a hummingbird feeder supporting pole or hook to repel ants therefrom;
Triggering the necrophobic instinct of ants to flee; and
Physically irritating the ants being blocked and repelled.

2. The method of claim 1 further comprising the following step:
Adding cinnamon oil to the composition, whereby the cinnamon oil acts as a fragrance and ant repellent.

3. The method of claim 1 in which fumed silica is used to thicken the composition, the method further comprising the following step:
Exposing the composition to air for a prolonged period of time such that oxidation of the oleic acid in the composition results in a crosslinking reaction making the composition more durable, wherein as the crosslinking reaction continues to take place over the prolonged period of time, the composition hardens.

4. The method of claim 1 wherein the thickening agent is a polymer, the method further comprising the following step:
Forming a barrier tape from the thickened polymer-containing composition having a predetermined width and thickness, and
Applying the barrier tape to a hummingbird feeder supporting pole or hook, wherein the tape can be wrapped around the pole or hook support of the hummingbird feeder to prevent ants from crossing the barrier tape and invading the hummingbird feeder.

5. The method of claim 1 further comprising the following steps:
Applying the gel composition to a portion of carrier substrate, the carrier substrate selected from the group of materials consisting of woven cloth fabric, polymer foam, natural fiber material, synthetic fiber material, polymer fabric, extruded material, and hook and loop material; and
Applying the carrier substrate around the circumference of the hummingbird feeder supporting pole or hook, whereby the gel composition applied to the carrier substrate forms a barrier to ants and thereby prevents the invasion of the hummingbird feeder by ants.
